(19) United States
(12) Patent Application Publication
(10) Pub. No.: US 2002/0103714 A1
(43) Pub. Date: Aug. 1, 2002

(54) System for processing customizable product orders over a computer network

(76) Inventor: I.O. A. Eze, Oakland, CA (US)

Correspondence Address: Todd A. Noah, Dergosits & Noah LLP, Suite 1150, Four Embarcadero Center, San Francisco, CA, 94111, US

(21) Appl. No.: 09/771,424

(22) Filed: Jan. 26, 2001

(51) Int. Cl. G06F 17/60

(52) U.S. Cl. 705/26

(57) ABSTRACT

A system for ordering and producing customizable limited edition garments is described A server computer executing a web page server process is coupled to a design database that stores production data related to one or more garments available for selection by a customer. The server computer is coupled to a client computer over a computer network. The client computer executes a web browser process that displays a graphical user interface screen provided by the server computer. The graphical user interface displays the one or more garments available for selection by the user and receives user input regarding ordering information and product customization information. An automated production system is coupled to the first computer and is configured to manufacture a garment selected by the user in response to user selection data and in accordance with production data for the selected garment stored in the design database.

### FIELD OF THE INVENTION

The present invention relates generally to a method of receiving and processing product orders, and more specifically to an on-line method for producing limited edition garments.

### BACKGROUND OF THE INVENTION

The marketing of limited edition or time-sensitive products presents unique problems to retailers and producers. Such products must be made available to a meaningful number of prospective customers and then produced in accordance with specific customer requirements. Because of the inherent time limited nature of the product, efficient ordering, production, and distribution systems are crucial to ensure that the proper products are distributed in a timely manner.

A classic type of limited edition product is designer clothing for the fashion industry. Fashion designers typically design and market a restricted set of high-end fashions each year. These garments are typically not meant for mass production, but are instead made available to a select clientele. It is often difficult for such designers and/or retailers to make their products available to a wide range of customers because of the inherent limitations of retail store sales.

Another disadvantage associated with present systems of marketing clothes is that because fit is very individualistic, it is often difficult and time-consuming for buyers to shop for custom or semi-custom clothing. Off the rack clothes are typically purchased directly from retail stores. Not only is it time-consuming and often difficult to shop for particular garments among a large selection of clothes, but the clothes as available off the rack may not fit optimally, thus requiring extra effort and expense to have the clothes altered or custom-tailored.

Although some computer-based systems have been developed for consumer clothing sales, such systems are not fully developed and have significant shortcomings. One such shortcoming is that present systems typically provide only a computer-based interface for existing retail operations. Production of the garment is not closely coupled to the selection and ordering processes, thus imposing a time delay in the ordering process. Moreover, such systems typically do not provide a true customizable or semi-customizable ordering process. Items that are available on-line are usually the same items that are available in the retail stores themselves. Dedicated user account information and customer preference information is usually not used to facilitate the ordering and production of customized garments.

What is needed, therefore, is an on-line product ordering and distribution system that provides a selection of limited edition products to a wide range of customers and that can produce and deliver the products in accordance with customer requirements in a time-efficient manner.

### SUMMARY OF THE INVENTION

A system for ordering, producing and distributing customizable apparel products is described. A server computer executing a web page server process is coupled to a design database that stores production data related to one or more garments available for s selection by a customer. The server computer is coupled to a client computer over a computer network. The client computer executes a web browser process that displays a graphical user interface screen provided by the server computer. The graphical user interface displays the one or more garments available for selection by the user and receives user input regarding ordering information and product customization information. An automated production system is coupled to the first computer and is configured to manufacture a garment selected by the user in response to user selection data and in accordance with production data for the selected garment stored in the design database.

Other features and advantages of the present invention will be apparent from the accompanying drawings and from detailed description that follows.

### BRIEF DESCRIPTION OF THE DRAWINGS

The present invention is illustrated by way of example and not limitation in the figures of the accompanying drawings, in which like references indicate similar elements, and in which:

FIG. 1 illustrates a computer network that includes client computers coupled to a server computer, and that is used to implement embodiments of the present invention;

FIG. 2 illustrates a web-browser based user interface for accessing a customizable garment ordering system, according to one embodiment of the present invention;

FIG. 3 illustrates an order input web page for the user interface illustrated in FIG. 2, according to one embodiment of the present invention;

FIG. 4 illustrates an order checkout web page for the user interface illustrated in FIG. 2, according to one embodiment of the present invention;

FIG. 5 is a flowchart that illustrates the steps of processing an on-line custom garment order, according to one embodiment of the present invention; and

FIG. 6 is a flowchart that illustrates the steps of a back-end production process for an on-line custom garment ordering system, according to one embodiment of the present invention.

### DESCRIPTION OF THE PREFERRED EMBODIMENTS

A system for processing production orders for limited use or time-sensitive products in an on-line product ordering system is described. In the following description, for purposes of explanation, numerous specific details are set forth in order to provide an understanding of the present invention. It will be evident, however, to those of ordinary skill in the art that the present invention may be practiced without the specific details In other instances, well-known structures and devices are shown in block diagram form to facilitate explanation. The description of preferred embodiments is not intended to limit the scope of the claims appended hereto.

Hardware Overview

Aspects of the present invention may be implemented on one or more computers executing software instructions According to one embodiment of the present invention, a server computer system transmits and receives data over a computer network or standard telephone line. The steps of accessing, downloading, and manipulating the data, as well as other aspects of the present invention are implemented by a central processing unit (CPU) in the server computer executing sequences of instructions stored in a memory. The memory may be a random access memory (RAM), read-only memory (ROM), a persistent store, such as a mass storage device, or any combination of these devices. Execution of the sequences of instructions causes the CPU to perform steps according to embodiments of the present invention.

The instructions may be loaded into the memory of the server computer from a storage device, or from one or more other computer systems over a network connection. For example, a client computer may transmit a sequence of instructions to the server computer in response to a message transmitted to the client over a network by the server. As the server receives the instructions over the network connection, it stores the instructions in memory. The server may store the instructions for later execution, or it may execute the instructions as they arrive over the network connection. In some cases, the downloaded instructions may be directly supported by the CPU. In other cases, the instructions may not be directly executable by the CPU, and may instead be executed by an interpreter that interprets the instructions. In other embodiments, hardwired circuitry may be used in place of, or in combination with, software instructions to implement the present invention. Thus, the present invention is not limited to any specific combination of hardware circuitry and software, nor to any particular source for the instructions executed by the server or client computers.

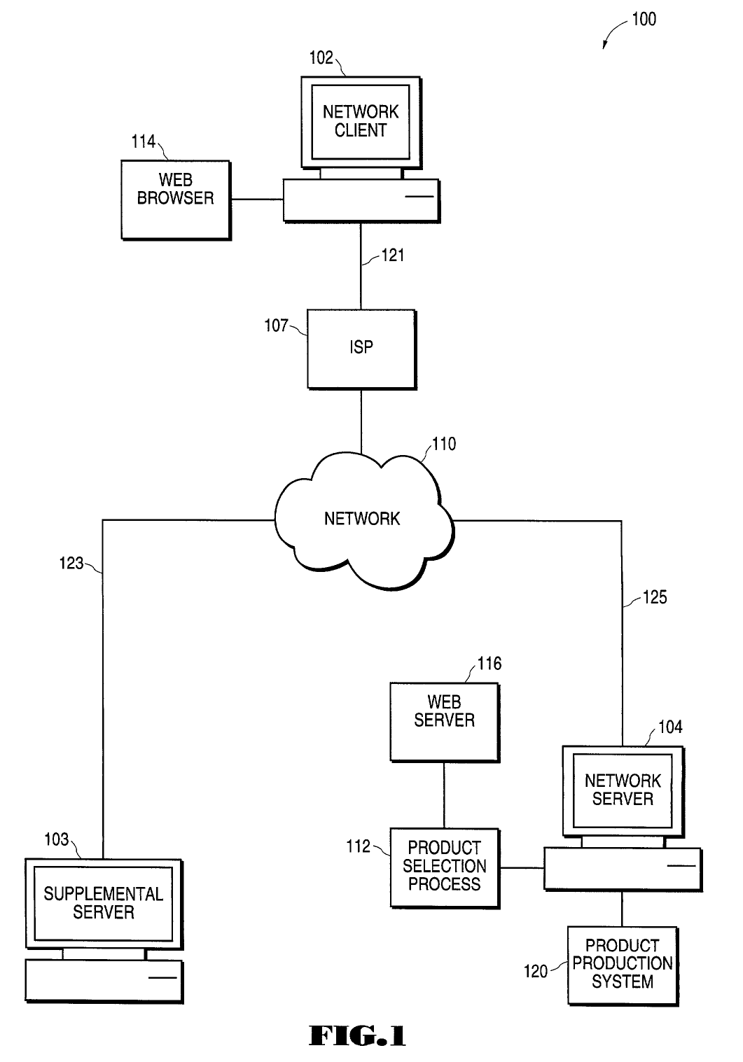

FIG. 1 illustrates a computer network system 100 that implements one or more embodiments of the present invention. In system 100, a network server computer 104 is coupled, directly or indirectly, to one or more network client computers 102 through a network 110. The network interface between server computer 104 and client computer 102 may also include one or more routers. The routers serve to buffer and route the data transmitted between the server and client computers. Network 110 may be the Internet, a Wide Area Network (WAN), a Local Area Network (LAN), intranet, extranet, wireless network, or any combination thereof.

In one embodiment of the present invention, the server computer 104 is a World-Wide Web (WWW) server that stores data in the form of ‘web pages’ and transmits these pages as Hypertext Markup Language (HTML) files over the Internet network 110 to one or more of the client computers 102. For this embodiment, the client computer 102 runs a “web browser” program to access the web pages served by server computer 104. Additional web based content can be provided to client computer 102 by separate content providers, such as supplemental server 103.

In one embodiment of the present invention, server 104 in network system 100 is a server that executes a product selection program or process 112. Product selection process 112 transmits and receives data from various other client computers, such as network client 102, and processes the received data to process requests received over network 110. Product selection process 112 may represent one or more executable program modules that are stored within network server 104 and executed locally within the server. Alternatively, however, product selection process 112 may be stored on a remote storage or processing device coupled to server 104 or network 110 and accessed by server 104 to be locally executed. In a further alternative embodiment of the present invention, product selection process 112 may be implemented in a plurality of different program modules, each of which may be executed by two or more distributed server computers coupled to each other, or to network 110 separately.

In one embodiment of system 100, the network server 104 is coupled directly or indirectly to a product production system 120. Product production system 120 produces the product or products selected by the user. The product selection process 112 receives product selection and customization information from the user and transmits this information to the product production process 120. The product is then produced to the user's requirements.

In one embodiment of the present invention, wherein network 110 is the Internet, network server 104 also executes a web server process 116 to provide HTML documents to client computers coupled to network 110. To access the HTML files provided by server 104, client computer 102 runs a web client process (typically a web browser) 114 that accesses and provides links to web pages available on server 104 and other Internet server sites. It should be noted that a network system 100 that implements embodiments of the present invention may include a larger number of interconnected client and server computers than shown in FIG. 1.

Product Ordering System

The product selection process 112 illustrated in FIG. 1 includes various software processes that coordinate the basic steps of providing a selection of products to a user, receiving a product order from the user, transmitting the product order data to the product production system 120, tracking the production and delivery of the product, processing payment for the product, and managing the user's account. In general, the product selection process represents a suite of programs or components that together provide adaptive, intelligent, and dynamic management of product selections and orders that involve various tasks and shared data elements and content. The product selection process may include or access local or remote databases that store various documents, data files, programs, and other objects associated with the product ordering process.

The components and sub-components of the on-line product selection process 112 may reside on different server and/or client computers in a distributed or networked computer system. Various embodiments of the present invention may be on-line implementations that utilizes the Internet network and various Internet-specific technologies. However, it should be noted that alternative embodiments of the present invention may utilize other types of network technologies. For example, the networks coupling the product selection process to various user clients may be implemented as any type of computer network, such as a private LAN (local area network), WAN (wide area network), intranet, extranet, wireless network or any combination thereof that connects two or more computers together.

Likewise, for the embodiment of the present invention in which the network utilized is the Internet, the product selection process is typically implemented through user interface programs that utilize web server and web browser programs. Alternatively, however, these document production processes can be implemented as proprietary or dedicated software programs that communicate over a public or private computer network that couples the on-line project management system to the users.

In one embodiment of the present invention, the product selection process provides an interface for a user to select and order limited edition designer garments online. Such garments are characterized as products that are available from a select group of producers, i.e., fashion designers, and are typically available only in limited quantities and for a short period of time. Because they are garments, the products must be produced to exact user specifications with regard to fit and size, and other options if available, such as fabric, color, and so on. The on-line selection and ordering system facilitates the presentation of available garments to a select group of users. It also provides an efficient method for providing product selection data to back-end production and distribution systems that can efficiently produce and deliver the specified garment to the user.

For this embodiment, the server computer 104 executing the product selection process is coupled to a separate computer, such as supplemental server 103 that includes or accesses a database containing a selection of garments. The garment data could include various data items related to the production of the garment, such as pattern information, fabric selection data, color data, sizing data, and so on. The product selection process 112 presents the selectable garments to the user along with various options that the user can select to customize the garment. In certain cases no options are provided, and the user is restricted to selecting the garment or product as it is presented. In certain other cases, various options may be provided, such as the size, cut, and/or color of a garment. In the case of certain limited run or restricted garments that are provided only in specific colors and patterns, only the size may be selected by the user.

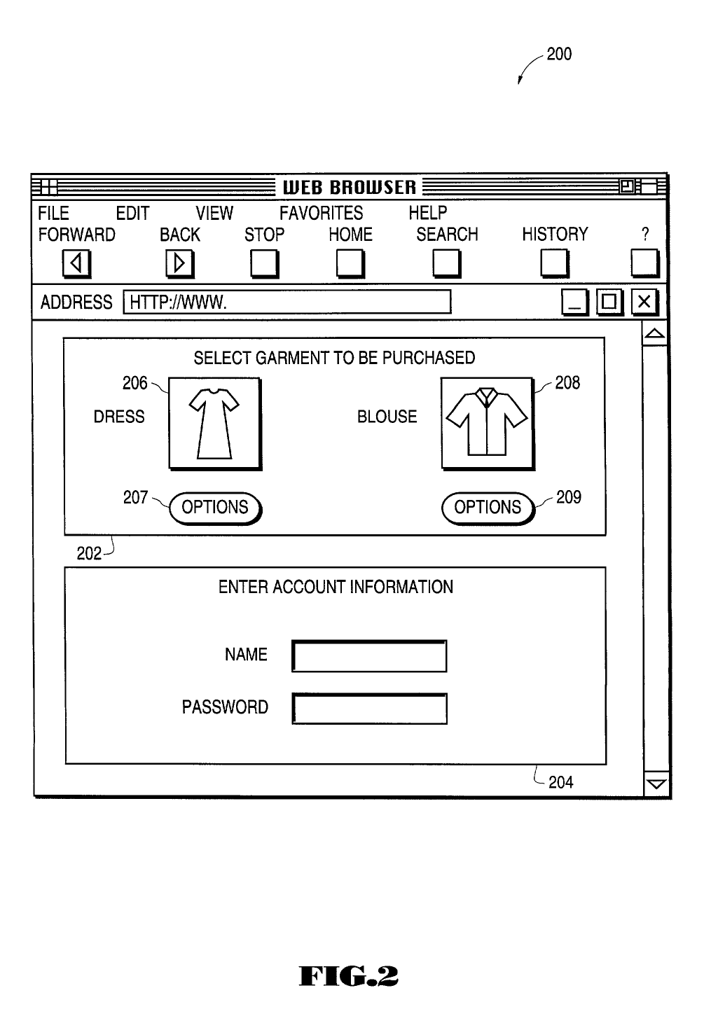

In one embodiment of the present invention, the product selection process is provided by the network server 104 in the form of an Internet-based web page served by web server process 116. The user interface includes a web browser window 200 that is displayed on the display screen of network client computer 102. The web site accessed by the web browser is served by web server process 116 on network server 104. The example illustrated in FIG. 2 illustrates a product selection process in which the product to be selected includes limited edition garments. The garments may be limited edition garments that are made available to a user for a limited period of time. In this case, the web site accessed from network server 104 may be an on-line store that provides a selection of designer or exclusive garments to users on a periodic basis. For the example illustrated in FIG. 2, two garment selections are provided, a dress and a blouse. The clothing selections are graphically illustrated in display fields 206 and 208. The clothes displayed for selection in the selection display area 202 may represent garments that are available from a specific designer and available only in a limited number of configurations, and for only a limited period of time, such as a week. The selection of garments is typically a time-limited rotating selection from one or more designers. For example the selection may include a particular dress in a specific color from designer A for one week, and then a blouse from designer B for the next week, and so on.

If any configuration options are available, the user may select option commands 207 and 209. Available options may include garment size, color, and other options For many limited run items in which the design of the garment is fixed, no option choices may be available, except for size. For other types of garments, certain options may be available, such as color or fabric selection.

User interface 200 also includes an account information display area 204 In one embodiment of the present invention, a user of the product selection process 112 establishes a user account to view the products available for sale and to place orders. In display area 204, the user enters identifier (e.g., name) and security (e.g., password) information to access his or her account. User interface 200 may also include commands or links to enable a user to set up new account or modify an existing account.

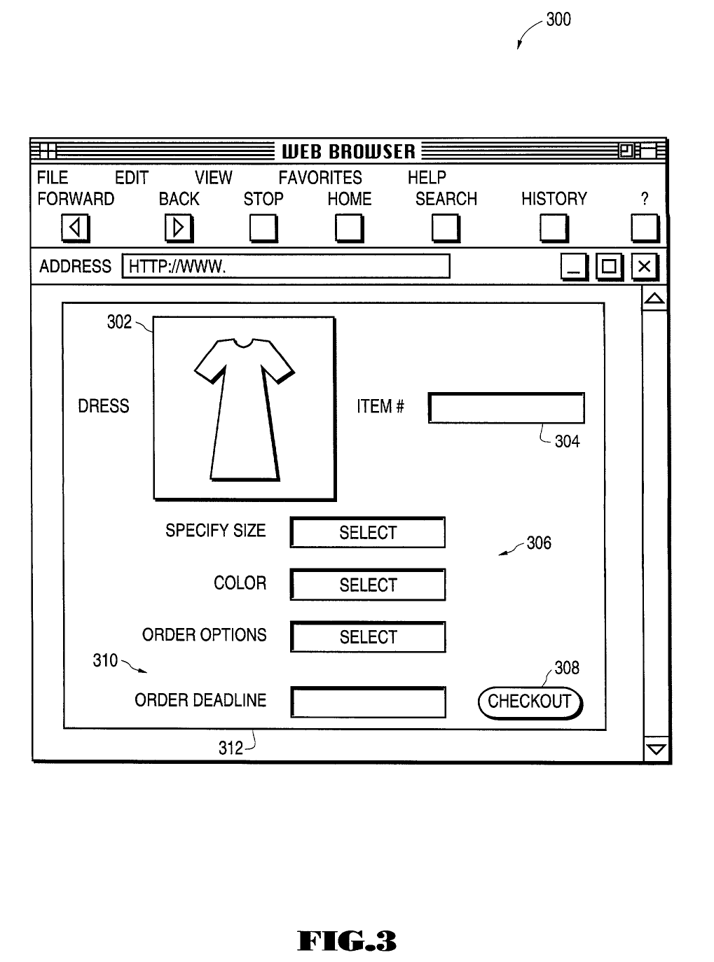

Once a user has selected a garment to be ordered, a product order page is displayed to enable the user to enter specific information related to the order. FIG. 3 illustrated a product ordering web page for the user interface of FIG. 2, according to one embodiment of the present invention. In display area 302, an enlarged picture of the selected garment is displayed. The garment may be displayed alone, on a model, or in a similar type of representation. Various different views or representations may be displayed if available. In one embodiment, if various options for the garment are available, such as color, the different options may be viewed through a pull-down menu or other similar display scheme. The associated item number for the garment is provided in field 304.

Option fields 306 provide input areas for the user to enter specific options, if any are available for the garment. For most garment products, at least a size must be selected, since this is typically the most variable characteristic of clothing from person to person. If other options, such as color are available for customization by the user, these options are also provided in interface screen 300. Selection of options available in the option field 306 may be provided in the form of pull-down menus. For example, for size, the pull-down options may include small, medium, large, extra-large, and so on. Alternatively, text entry fields may be provided for the user to enter critical dimensions, such as bust, waist, height, hip, and other relevant measurements.

In one embodiment of the present invention, the account information associated with a particular user may include personal data that relates to the type of product available to be ordered. For example, user account data may include a person's measurements so that sizing information is automatically provided when the person orders a garment. Similarly color preferences, fabric preferences, and other similar types of user specific data may be included so that aspects of the product ordering process may be automated.

In an alternative embodiment of the present invention, the customer data may be imported to the product selection process through a separate database that includes customized specification data obtained specifically for the customer. For apparel products, for example, such data could be fit and measurement data that is obtained through a computer-based measurement system. Finite element analysis methods, or vector modeling methods, or similar modeling and measurement methods may be used to obtain the critical measurements parameters for a person. This data can then be downloaded to the product selection process to provide the relevant fit data required to produce the garment to the customer's requirements.

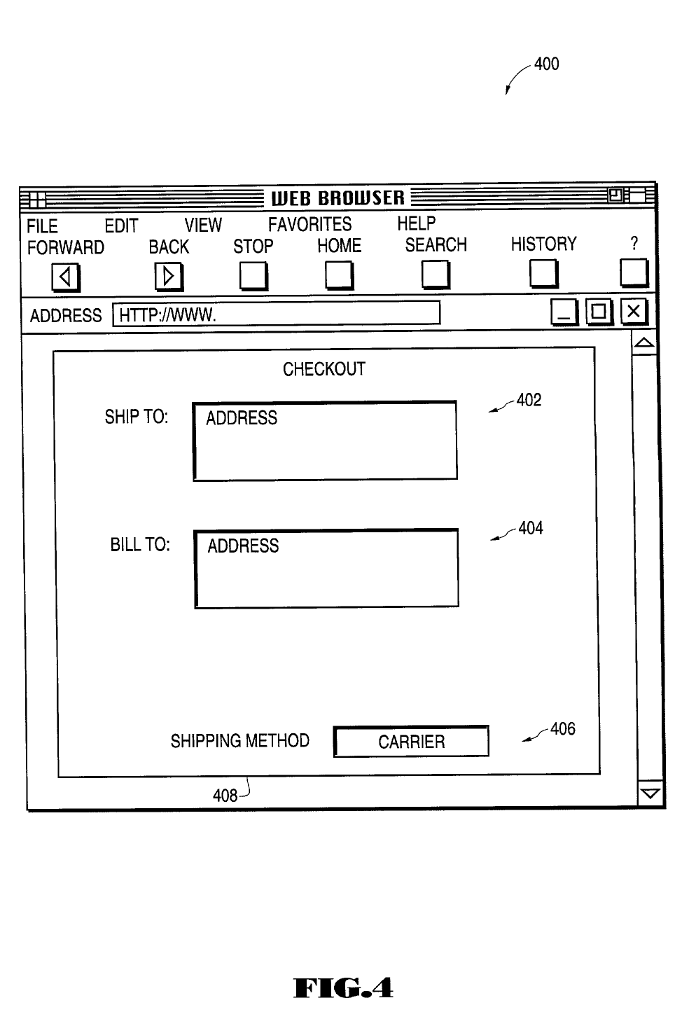

Certain products may be available for only a limited period of time. For this situation an order deadline 310 may be displayed Once the user has specified all of the information regarding the product, the user can proceed to finalize the product order by selecting a “checkout” 308 or similar command. FIG. 4 illustrates an exemplary product ordering web page for the user interface of FIG. 2, according to one embodiment of the present invention. In the checkout web page 400 includes a display area 408 in which the user enters or validates his or her shipping address 402 and billing address 404. If various delivery choices are available, a delivery method selection field 406 may be provided.

Once the user has selected a garment to be ordered and specified the requisite configuration information, the product selection process 112 transmits the product specification data to a back-end production process 120. For the embodiment of the present invention in which the product is clothing, the back-end production process 120 comprises an automated cutting and sewing facility that automatically cuts and fabricates garments in accordance with manufacturing data provided by the garment designer.

For example, if supplemental server 103 provides the garment designs, the product production system 120 receives manufacturing data from the supplemental server 103. Upon selection of garment by a user, production system 120 produces the ordered garment in accordance with the manufacturing data and any option data provided by the product selection process.

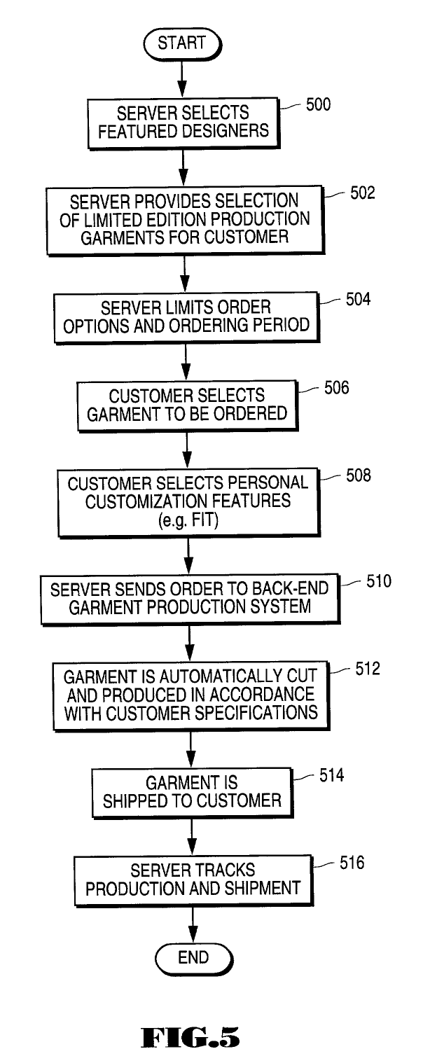

FIG. 5 is a flowchart that illustrates the process of selecting and producing customizable products for a user, according to a method of the present invention. For the method illustrated in FIG. 5, the product is a special order garment, such as that illustrated and described with reference to FIG. 2. In certain cases, the products to be provided for selection by the user comprise a subset selected from a group of products. For example, the user may provide one or more garments from a specific designer or retail store for selection. Thus, in step 500, the server selects a featured designer or source. The server then provides a selection of limited edition products (garments) for the user, step 502. Because the featured products are limited edition products, certain restrictions are placed on the range of configuration options available and period of availability, step 504.

As illustrated in FIG. 2, the garments that are available to be ordered at a particular period of time are displayed on a web page accessed on the customer's client computer. The customer then selects the garment or garments to be ordered, step 506. In step 508; the customer selects any options or customization features that may be available. For garments, the typical option to be specified is the fit or size of the garment. Once the customer completes the order, the order is transmitted to the back-end production system, step 510. The garment is then automatically cut and manufactured in accordance with manufacturing data provided by the designer, step 512. In step 514, the garment is delivered to the customer in accordance with any specific delivery instructions provided by the customer. Throughout the back-end production process, the server tracks the manufacturing and delivery processes to ensure that the ordered product is correctly provided to the customer, step 516.

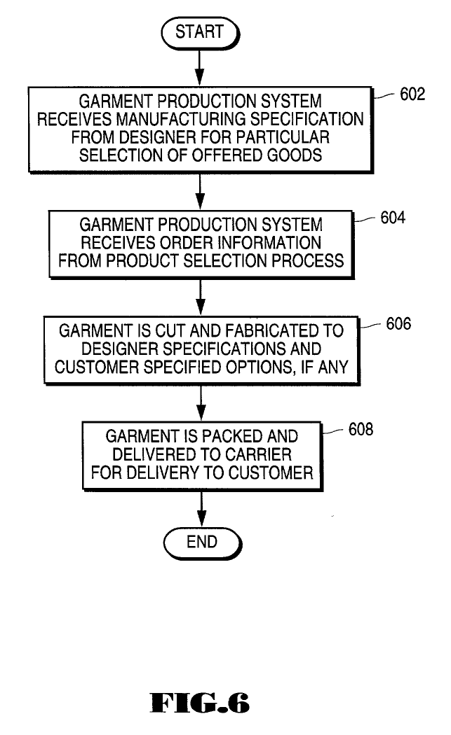

FIG. 6 is a flowchart that illustrates the processes involved in the back-end manufacturing process for the garment production and delivery method illustrated in FIG. 5. In step 602, the production system 120 receives the manufacturing specification from the designer for the particular selection of offered garments. Thus, for the example illustrated in FIG. 2, the production system 120 receives the pattern, fabric, cutting instructions and other similar data for the dress and blouse pictured in display field 202 The customer may leave one or more of the manufacturing parameters open for selection. In general, however, the production process will possess the necessary data to produce all likely variants of each offered garment.

Upon selection of a garment by a customer, the production system 120 receives the order information from the product selection process 112. The order and item data are typically associated with the garment to be produced through an item number 304 referenced by the product selection process 112. If any options are available to the user to customize the selected garment, these data items are used to modify the fabrication instructions defining the product by the production system 120. For example, a garment may be cut to a specific pattern, but may be sized depending upon the customer specification. This is shown as step 604 in FIG. 6. In step 606, the garment is cut and fabricated in accordance with the designer specifications and customer specified options. The garment is then packed and delivered to a carrier for delivery to the customer, step 608.

For the embodiment illustrated in FIG. 6, the production system may employ computer-controlled mechanical or laser-cutting machines to automatically cut the fabric for each garment. Automatic assembly or sewing machines may then be used to fabricate the finished garment. In this manner, production of the garment is closely coupled with the selection and ordering process, thus allowing for fast production of customer orders.

Although embodiments of the present invention were described and illustrated with reference to clothing, it should be noted that alternative embodiments could be directed to other types of products. Such products are typically limited edition or short-run products that are customizable to a certain degree and require some degree of production processing prior to delivery to the user. For example, the apparel products could include footwear, such as shoes, boots, and sandals; sports apparel, such as customizable helmets, body armor, or limb pads; or fashion accessories, such as handbags, jewelry, and so on. Other examples of such products include entertainment products, such as movie videos that may be available on various types of media, food products that are produced according to specific recipes and delivered to the user, and other similar products.

The customizable product ordering and production system can also be used to allow a user to order certain household products, such as appliances or personal computers. For personal computers, for example, a customer may be allowed to select a particular hardware platform, then customize the computer system by specifying particular peripheral devices, software applications, and so on. For this embodiment, the system may provide a selection of particular base components with particular optional selections and then use a pre-defined user-specified preference list to manually or automatically configure the computer to the user's specification.

In the foregoing, a web-based system has been described for producing custom products, such as limited edition designer clothes. Although the present invention has been described with reference to specific exemplary embodiments, it will be evident that various modifications and changes may be made to these embodiments without departing from the broader spirit and scope of the invention as set forth in the claims. Accordingly, the specification and drawings are to be regarded in an illustrative rather than a restrictive sense.

What is claimed is:

1. A computer-implemented method of processing production orders for limited edition products, comprising the steps of:
providing a selection of one or more products from a set of product providers through a web-based product selection process from a server computer coupled to a computer network;
receiving an order for a product from the selection of one or more products provided on a web-based user interface executed on a client computer coupled to the network;
providing product fabrication data to a production system closely coupled to the server computer executing the selection process;
producing the product in accordance with the fabrication data and customer provided data; and
delivering the product to the customer.

2. The method of claim 1 wherein the product is a limited edition garment produced to specifications specified by the customer.

3. The method of claim 2 wherein the product providers comprise one or more garment designers.

4. The method of claim 3 wherein the customer provided data comprises at least one of size, shape, color or fabric for the limited edition garment.

5. The method of claim 1 further comprising the step changing the selection of one or more products displayed on the client web-based user interface on a periodic basis.

6. The method of claim 2 further comprising the step of automatically cutting and assembling the product through production processes controlled by the product selection process.

7. The method of claim 2 wherein the product fabrication data comprises physical measurements for the customer, and wherein the physical measurements are obtained using a computer based method of measuring the customer comprising one of finite element analysis methods and vector modeling methods.

8. The method of claim 1 wherein the product is an electronic appliance, and wherein the product fabrication data comprises peripheral products used in conjunction with the product that modify functionality of the product.

9. A system for ordering and producing customizable limited edition garments, comprising:
a first computer executing a web page server process;
a design database coupled to the first computer, the database storing production data related to one or more garments available for selection by a user;
a second computer coupled to the first computer over a computer network and executing a web browser process; and
an automated production system coupled to the first computer and configured to manufacture a garment selected by the user in response to user selection data and in accordance with production data for the selected garment stored in the design database.

10. The system of claim 9 wherein the design database is maintained by a designer of the garment.

11. The system of claim 9 further comprising a graphical user interface displayed on the web browser of the second computer, the graphical user interface including a product selection display area displaying one or more garments selectable by the user to be produced by the automated production system.

12. The system of claim 10 wherein the graphical user interface further includes one or more configuration options selectable by the user to modify the one or more garments selectable by the user.

13. The system of claim 12 wherein the one or more configuration options include at least one of a garment size, shape, color, or material.

14. The system of claim 12 further comprising a user database coupled to the first computer, the user database including user identification information, user address information, and user specific preference information regarding one or more characteristics associated with the garments selectable by the user.

15. The system of claim 14 wherein the user specific preference information regards clothing measurement information for the user.

16. The system of claim 15 wherein the size of a garment selected by the user is automatically determined using the clothing measurement information for the user.

17. The system of claim 16 wherein the clothing measurement information for the user is obtained through electronic measurement methods comprising one of finite element analysis methods and vector modeling methods, and wherein the clothing measurement information is stored in a database accessible by the first computer.

18. A server computer for ordering and producing customizable limited edition garments, comprising:
a network interface device coupling the server computer to a client computer;
a web page server process;
a design database storing production data related to one or more garments available for selection by a user operating the client computer through a web browser process; and
an automated production system configured to manufacture a garment selected by the user in response to user selection data and in accordance with production data for the selected garment stored in the design database.

19. The server computer of claim 18 wherein the design database is maintained by a designer of the garment.

20. The server computer of claim 19 further comprising a graphical user interface displayed on the web browser of the client computer, the graphical user interface including a product selection display area displaying one or more garments selectable by the user to be produced by the automated production system.
